(19) United States
(12) Patent Application Publication
(10) Pub. No.: US 2014/0190085 A1
(43) Pub. Date: Jul. 10, 2014

(54) Vertically Sliding Door Assembly

(71) Applicant: Marinus Van Ingen, Ursem (NL)

(72) Inventor: Marinus Van Ingen, Ursem (NL)

(73) Assignee: Assa Abloy Entrance Systems AB, Landskrona (SE)

(21) Appl. No.: 14/129,404

(22) PCT Filed: Jun. 12, 2012
(86) PCT No.: PCT/EP2012/061050

§ 371 Date: Feb. 13, 2014

(30) Foreign Application Priority Data
Jun. 29, 2011 (SE) 1100505-5

(51) Int. Cl. E05F 15/16; E04H 5/00

(52) U.S. Cl. CPC E05F 15/1661; E04H 5/00
USPC 49/70

(57) ABSTRACT

A vertically sliding door assembly, in particular in the wall (3) of a docking station of a warehouse, comprising a vertically sliding door panel (4) having an inner surface and an outer surface, two vertical guide systems (5) each mounted adjacent one lateral side of a wall opening (2) and arranged to guide said sliding door panel (4) in a vertical direction between a closed position wherein said wall opening (2) is closed by said door panel (4) and an open position wherein said wall opening (2) is open, and driving means (6, 7) for moving said door panel (4) in vertical direction between said open and closed positions, and wherein said guide systems (5) each comprise two vertically extending slide bearing surfaces (15), a first one of said slide bearing surface (15) facing the inner surface of said door panel (4) and the second one of said slide bearing surface (15) facing said outer surface of said door panel (4), such that movement in the direction perpendicular to said inner and outer surfaces of said door panel (4) is substantially blocked by said slide bearing surfaces (15) while moving in the vertical direction.

The invention relates to a vertically sliding door assembly, in particular in the wall of a docking station of a warehouse, comprising a vertically sliding door panel having an inner surface and an outer surface, two vertical guide systems each mounted adjacent one lateral side of a wall opening and arranged to guide said sliding door panel in a vertical direction between a closed position wherein said wall opening is closed by said door panel and an open position wherein said wall opening is open, and driving means for moving said door panel in vertical direction between said open and closed positions.

Such door assemblies are well known in the art. Usually the door panel is guided by guide wheels which are attached to the side of the door panel and which run in two vertical rails mounted adjacent and above the wall opening.

The invention aims at a more simple and/or more reliable door assembly, and/or which is more safe for people and/or which can be mounted more easily, and/or which can seal a room more hermetically and/or which can be designed with more aesthetic value.

To that end said guide systems each comprise two vertically extending slide bearing surfaces, a first one of said slide bearing surface facing the inner surface of said door panel and the second one of said slide bearing surface facing said outer surface of said door panel, such that movement in the direction perpendicular to said inner and outer surfaces of said door panel is substantially blocked by said slide bearing surfaces while moving in the vertical direction.

Said door panel and said guide systems are preferably provided with means to block lateral movement of said door panel while moving in vertical direction.

Said means to block lateral movement of said door panel preferably comprise two third vertically extending bearing surfaces, preferably being slide bearing surfaces, extending in said vertical guide systems, said two slide bearing surfaces facing opposite lateral directions, and two bearing bodies extending from said door panel, each bearing body facing one of said third bearing surfaces, thereby blocking lateral movement.

Said guide systems preferably each comprise a profiled beam with a substantially C-shaped cross section, wherein said first and second slide bearing surfaces being formed by the mutually facing surfaces at the two outer ends of said C-shaped cross section.

Preferably said third bearing surfaces are each formed by a vertically extending strip shaped surface area adjacent one of the outer ends of said C-shaped cross section.

Said bearing bodies preferably extend from said door panel near the lower end of said door panel.

Said bearing surfaces and/or said bearing body are preferably made of low friction material, for instance a low friction plastic material. Alternatively said bearing body can be a roll bearing body such as a small wheel which runs against said bearing surface.

Said first and second slide bearing surfaces are preferably provided with flexible, for instance rubber, vertically extending strips extending obliquely in a lateral direction and towards said door panel, such that the outer ends of said flexible strips rest on the respective inner and outer surfaces of said door panel if the door panel extends between said slide bearing surfaces.

Said slide bearing surfaces are preferably provided on vertically extending plastic and/or rubber strips which are mounted on the outer ends of said substantially C-shaped cross section.

Each of said profiled beams preferably comprises two beam parts, each having a substantially J-shaped cross section, which beam parts are mounted to the wall such that they together form said beam with said substantially C-shaped cross section.

Said beam parts are preferably provided with adjusting means such that the distance between the outer ends of said C-shaped cross section can be set in dependence of the thickness of the door panel.

Said adjusting means are preferably comprised of slotted holes in said beam parts and screwing means which are used to connect said beam parts.

Said driving means are preferably arranged to apply a lifting force to said door panel near the lower end of said door panel, preferably to at least one lateral side thereof.

Said driving means preferably comprise a driven cord which is attached at one point, preferably near the lower end, to one side of said door panel, and which cord extends inside said substantially C-shaped beam. The term cord in this respect must be understood as to include a rope, a belt, a chain, etcetera.

Said door assembly further preferably comprises spring means which, in the closed position of the door panel apply a lifting force to said door panel near the lower end of said door panel.

The invention will be illustrated by means of a preferred embodiment as shown in the drawings, wherein:

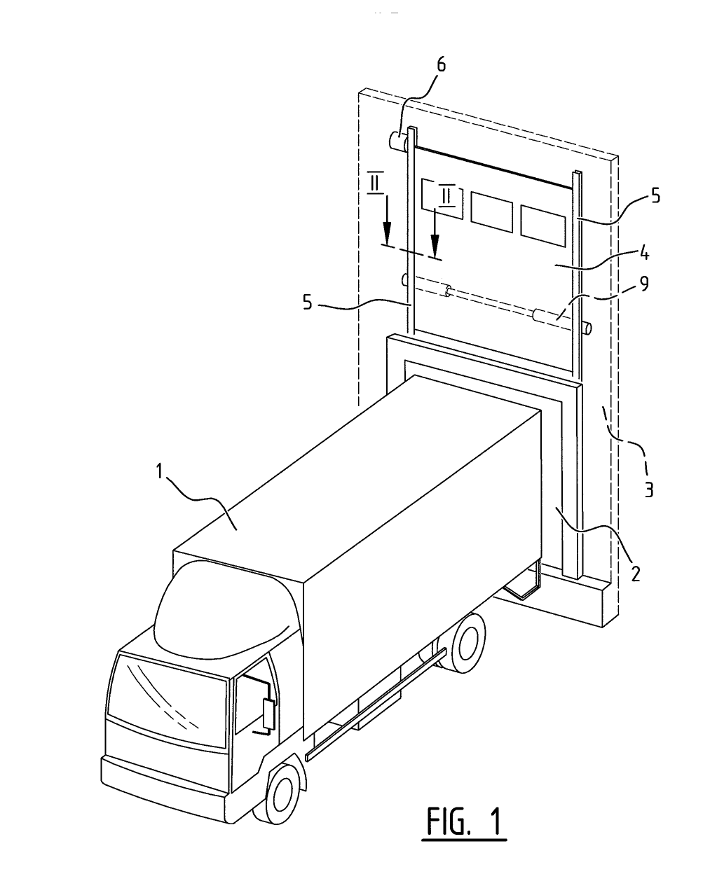

FIG. 1 is a perspective view of a docking station of a warehouse with a sliding door assembly in accordance with the invention;

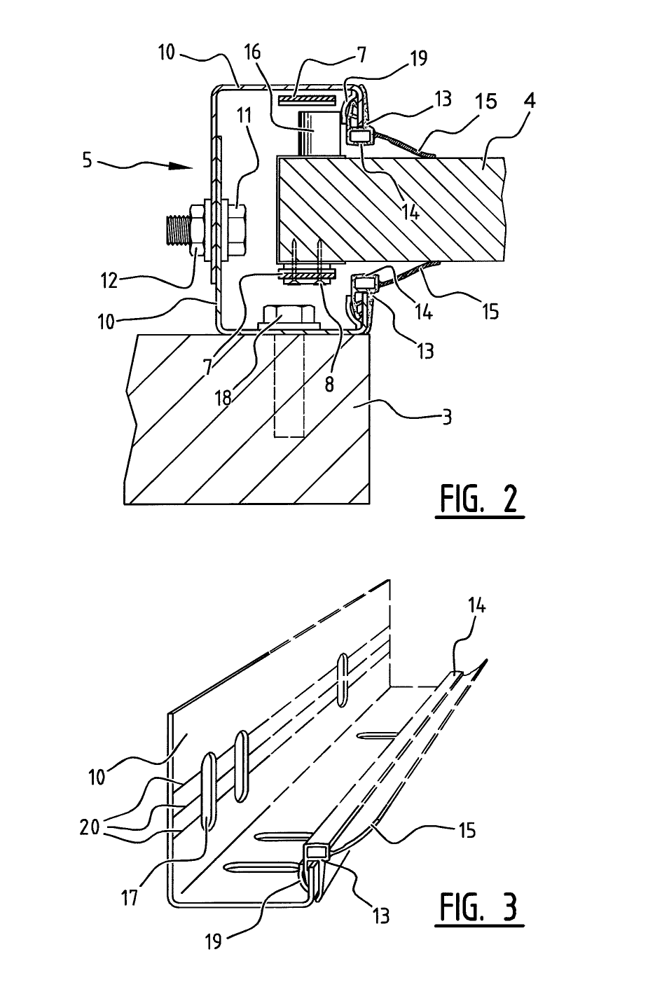

FIG. 2 is a cross section of a part of the sliding door assembly as indicated by arrows II-II in FIG. 1; and

FIG. 3 is a perspective view of a substantially J-shaped profiled beam as used in the sliding door assembly of FIGS. 1 and 2.

According to FIG. 1 a warehouse comprises a docking station where a truck 1 can park in order to load or unload cargo. The docking station comprises an opening 2 in the wall 3 of the warehouse (shown in dashed lines) which substantially matches the back door opening of the truck 1.

In order to close the door opening 2, a door panel 4 is slidably mounted in two vertical guides 5 against the inner side of the wall 3. The door panel 4 can be made of several panel sections which are connected to each other, and can be comprised of a light weight insulating core such as foamed plastic, and a metal sheet outer shell, for instance of aluminium.

The lower halves of the guides 5 are mounted adjacent the door opening 2 and extend upward to approximately two times the height of the door opening 2. The door panel 4 can slide up and down in the guides 5, such that in the upper position of the door panel 4 the door opening is open, and in the lower position of the door panel 4 the door opening is closed. The door panel 4 is driven by an electrical motor 6 by an endless cord, for instance a toothed rubber belt 7 which extends inside the guide 5 at the left lateral side of the door panel 4. At its upper side the toothed belt 7 runs over a gear wheel which is driven by said motor 6, and at its lower side the toothed belt 7 runs over a free running gear wheel. The endless belt 7 is connected with the door panel 4 near the lower end of the door panel 4 by screws 8.

At the lower end of the door panel 4 two cables (not shown) are attached to the lateral sides of the door panel 4 in a similar manner. Said cables also run inside the guides 5, extending up from the upper end of the door panel over guide wheels at the upper ends of the guides 5 down towards a torque spring 9, such that the upward force of the cables is approximately equal to the downward gravitational force of the door panel 4. Thereby the motor 6 only needs the relatively small power for moving the door panel 4 up and down, instead of the relatively large power necessary to lift the door panel's weight.

Referring to FIGS. 2 and 3, the guides 5 each comprise two profiled beams 10 having a substantially J-shaped cross-section (as shown in FIG. 3), which are preferably made of bent metal sheets. Said profiled beams 10 are connected to each other by means of screws 11 and bolts 12, such that they form a combined profiled beam having a substantially C-shaped cross-section (as shown in FIG. 2). The profiled beams 10 are provided with slotted screw holes 17, such that the distance between the outer ends of the C-shape can be adjusted for different thicknesses of door panels 4. Indicators 20 for different thicknesses of door panels are provided on the inner side of the profiled beams 10 such that the correct distance is set when connecting the profiled beams 10 to each other. The combined C-shaped profiled beam is mounted against the inner wall 3 by means of screws 18.

The outer ends (seen in cross section) of the profiled beams 5, between which the door panel 4 extends, are provided with slide bearing strips 13, such that the panel 4 can move up and down with relatively low friction. To that end the slide bearing strips 13 are generally made of a low friction material such as plastic, and furthermore the distance between the main bearing surfaces 14 of said strips is larger than the thickness of the door panel 4 and the strips 13 are provided with flexible strips 15 which extend from said slide bearing strips 13 in an oblique direction towards the door panel 4, such that the outer ends of the flexible strips 15 rest against the respective surfaces of the door panel 4. In that manner the door is substantially hermetically closing the door opening of the warehouse in the closed position of the door panel 4, such that for instance an overpressure can be maintained inside the warehouse. The slide bearing strips 13 with the flexible strips 15 are preferably co-extruded.

In order to prevent lateral movement of the door panel 4, at each lateral side of the door panel 4, near its lower end, a plastic cylindrical projection 16 is mounted against the inner or outer surface of the door panel, such that the smooth cylindrical surfaces of the projections 16 rest against the inner side of the corresponding outer end (seen in cross-section) of the profiled beam 10. Inner slide bearing strip parts 19 of the slide bearing strips 13 having a low friction surface extend on said inner side of the profiled beams 10, such that said projections 16 can easily slide along the profiled beams 10.

Although the invention is exemplified by one embodiment thereof, the scope of the current teaching is not restricted to said embodiment. The skilled person will appreciate that many modifications can be made and that equivalent features may substitute the described features without departing from the teachings of the invention.

1. A vertically sliding door assembly, in particular in the wall of a docking station of a warehouse, comprising a vertically sliding door panel having an inner surface and an outer surface, two vertical guide systems each mounted adjacent one lateral side of a wall opening and arranged to guide said sliding door panel in a vertical direction between a closed position wherein said wall opening is closed by said door panel and an open position wherein said wall opening is open, and driving means for moving said door panel in vertical direction between said open and closed positions, characterized in that wherein said guide systems each comprise two vertically extending slide bearing surfaces, a first one of said slide bearing surface facing the inner surface of said door panel and the second one of said slide bearing surface facing said outer surface of said door panel, such that movement in the direction perpendicular to said inner and outer surfaces of said door panel is substantially blocked by said slide bearing surfaces while moving in the vertical direction.

2. The vertically sliding door assembly in accordance with claim 1, wherein said door panel and said guide systems are provided with means to block lateral movement of said door panel while moving in vertical direction.

3. The vertically sliding door assembly in accordance with claim 1, wherein said means to block lateral movement of said door panel comprise two third vertically extending bearing surfaces, preferably being slide bearing surfaces, extending in said vertical guide systems, said two third bearing, surfaces facing opposite lateral directions, and two bearing bodies extending from said door panel, each bearing body facing one of said third bearing surfaces, thereby blocking lateral movement.

4. The vertically sliding door assembly in accordance with claim 3, wherein said bearing bodies extend from said door panel near the lower end of said door panel.

5. The vertically sliding door assembly in accordance with claim 1, wherein said guide systems each comprise a profiled beam with a substantially C-shaped cross section, wherein said first and second slide bearing surfaces being formed by the mutually facing surfaces at the two outer ends of said C-shaped cross section.

6. The vertically sliding door assembly in accordance with claim 5, wherein said third bearing surfaces are each formed by a vertically extending strip shaped surface area adjacent one of the outer ends of said C-shaped cross section.

7. The vertically sliding door assembly in accordance with claim 1, wherein said slide bearing surfaces and/or said bearing body are made of low friction material, for instance a low friction plastic material.

8. The vertically sliding door assembly in accordance with claim 1, wherein said first and second slide bearing surfaces are provided with flexible, for instance rubber, vertically extending strips extending obliquely in a lateral direction and towards said door panel, such that the outer ends of said flexible strips rest on the respective inner and outer surfaces of said door panel if the door panel extends between said slide bearing surfaces.

9. The vertically sliding door assembly in accordance with claim 5, wherein said slide bearing surfaces are provided on vertically extending plastic and/or rubber strips which are mounted on the outer ends of said substantially C-shaped cross section.

10. The vertically sliding door assembly in accordance with claim 5, wherein each of said profiled beams comprises two beam parts, each having a substantially J-shaped cross section, which beam parts are mounted to the wall such that they together form said beam with said substantially C-shaped cross section.

11. The vertically sliding door assembly in accordance with claim 10, wherein said beam parts are provided with adjusting means such that the distance between the outer ends of said C-shaped cross section can be set in dependence of the thickness of the door panel.

12. The vertically sliding door assembly in accordance with claim 11, wherein said adjusting means are comprised of slotted holes in said beam parts and screwing means which are used to connect said beam parts.

13. The vertically sliding door assembly in accordance with claim 1, wherein said driving means is arranged to apply a lifting force to said door panel near the lower end of said door panel.

14. The vertically sliding door assembly in accordance with claim 5, wherein said driving means comprise a driven cord which is attached at one point, preferably near the lower end, to one side of said door panel, and which cord extends Inside said substantially C-shaped beam.

15. The vertically sliding door assembly in accordance with claim 1, wherein said door assembly further comprises spring means which, in the closed position of the door panel apply a lifting force to said door panel near the lower end of said door panel.
